(19) United States
(12) Patent Application Publication
(10) Pub. No.: US 2015/0127399 A1
(43) Pub. Date: May 7, 2015

(54) SYSTEM AND METHOD OF AUTOMATICALLY ALLOCATING TASKS

(71) Applicant: Mitchell International, Inc., San Diego, CA (US)

(72) Inventors: Basab Dattaray, San Diego, CA (US); Bryan Durant, San Diego, CA (US)

(73) Assignee: Mitchell International, Inc., San Diego, CA (US)

(21) Appl. No.: 14/070,160

(22) Filed: Nov. 1, 2013

(51) Int. Cl. G06Q 10/06

(52) U.S. Cl. CPC G06Q 10/063112
USPC 705/7.14

(57) ABSTRACT

Systems and methods of allocating tasks to servicers are disclosed. The systems and methods generate task/servicer pairings, each pairing identifying one of the tasks and one of the servicers. Ranks are generated for the pairings, and pairings are selected for potential allocation based on the ranks. If the task of a pairing is allocatable to the servicer of the pairing, the task is allocated to the servicer. If the task of a pairing is not allocatable to the servicer of the pairing, a next pairing is selected.

### BACKGROUND

The present invention generally relates to systems and methods of allocating multiple tasks to multiple servicers, and more particularly to systems and methods of allocating tasks to servicers, where each of the tasks and each of the servicers are associated with a geographical location.

Various industries provide services to customers at different locations. For example, a real estate appraisal service provider uses a number of real estate appraisers to generate appraisals for properties at different locations on behalf of a number of real estate owners. Each day, for example, each appraiser receives a number of assignments for appraisal tasks to be performed at different locations.

The problem of determining which appraiser should receive which of the appraisal tasks is computationally complex and can require large amounts of computing resources to perform. Because the problem is NP-complete (nondeterministic polynomial time), an optimum solution may be found only by considering all possible solutions, and comparing the solutions based on a metric or rule whose outcome is to be optimized.

The metric to be optimized may be the outcome of, for example, finishing all of the appraisal tasks as early as possible, based on estimated durations of each of the appraisal tasks and estimated durations of other activities of each of the appraisers, such as travel, documentation, and the like. In such an example, to find the optimum solution, all possible solutions are calculated, and the completion time of the last time of appraisal of all the appraisers is calculated for each of the solutions. The solution having the earliest (minimum) last completion time is then selected as the optimum solution.

The computational load for finding an optimum solution increases exponentially with the number of appraisals and the number of appraisers. Because all possible solutions are calculated, this method of distributing appraisal tasks is impractical for situations having more than a few appraisers.

### Brief Summary

### BRIEF DESCRIPTION OF THE DRAWINGS

FIG. 1 is a schematic illustration of an exemplary task allocation system.

FIG. 2 is a graphical illustration of a task allocation problem for a service provider.

FIG. 3 is a structured flowchart diagram illustrating a method used by a computer to allocate tasks.

FIG. 4 is a graphical illustration of a task allocation problem for a service provider.

FIG. 5 shows a configuration for a computer system constructed in accordance with the present disclosure.

### DETAILED DESCRIPTION

Particular embodiments of the invention are illustrated herein in conjunction with the drawings.

Various details are set forth herein as they relate to certain embodiments. However, the invention can also be implemented in ways which are different from those described herein. Modifications can be made to the discussed embodiments by those skilled in the art without departing from the invention. Therefore, the invention is not limited to particular embodiments disclosed herein.

In order to allocate tasks for more than a few servicers, finding an optimum solution may be impractical. However, using embodiments of systems and methods described herein, a near optimum solution may be calculated using a practical amount of computing resources and time.

Numerous industries allocate tasks among multiple servicers, and may benefit from the embodiments discussed herein. Industries such as home or building repair services, sales, claims processing, and mail or package delivery, which serve customers at different locations using multiple servicers, are particularly benefited by the embodiments discussed herein. While real estate appraisal services are discussed herein as an example, the various aspects and principles presented also apply to other industries.

In the examples, appraisers function as servicers, who are those assigned with performing the appraisal task. Each appraisal task is assigned to one of the appraisers. The appraisal tasks are allocated to each of the various appraisers by a computer system according to aspects and principles of the exemplary methods described below.

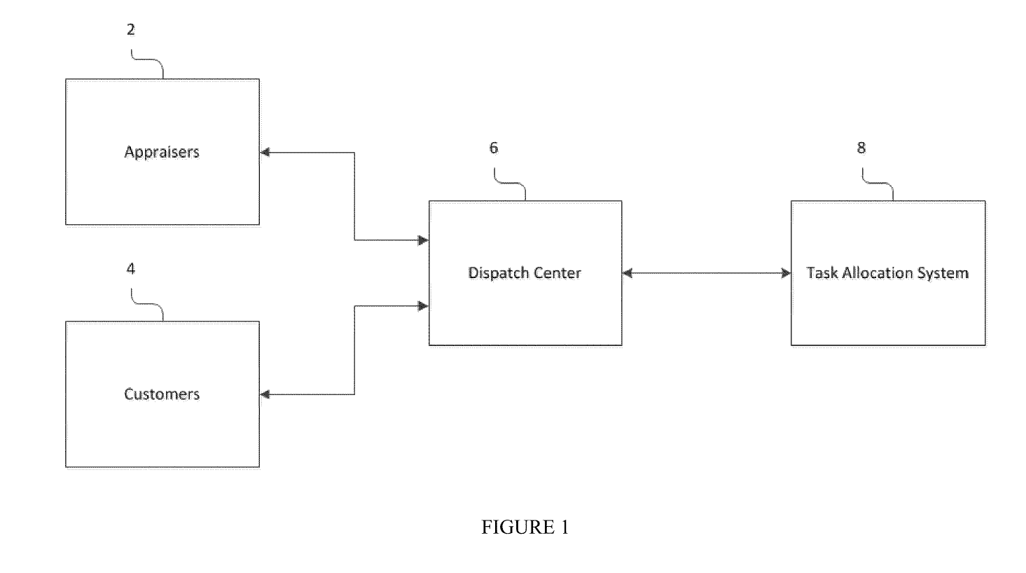

FIG. 1 is a schematic illustration of an exemplary task allocation system. The system includes appraisers 2, who provide information, for example regarding their availability, to a dispatch center 6, for example via an electronic communications network connecting the two. The FIG. 1 system also includes customers 4, who request appraisal jobs from the dispatch center 6, for example via an electronic communications network connecting the two. In some embodiments, the customers may include one or more insurance companies, which are in need of appraisers to assess damages for claims processing. Although the appraisers 2 are represented by a single box in FIG. 1, it should be understood that a plurality of appraisers are represented by the single box 2. Similarly, the customers 4 are represented by a single box in FIG. 1, but comprise a plurality of customers.

The dispatch center 6 receives the information from the appraisers 2 and the requests from customers 4. The information from the multiple sources may be packaged, and delivered from the dispatch center 6 to a task allocation system 8, for example via an electronic communications network connecting the two.

The task allocation system 8 receives the information regarding the appraisers 2 and the requested appraisal jobs or tasks, and allocates the appraisal jobs or tasks among the appraisers 2. Once the allocations have been determined, the task allocation system 8 communicates the allocations to the dispatch center 6 via the network. The dispatch center 6 communicates the allocations for each appraiser to the respective appraisers via the network. In some embodiments, the dispatch center 6 also communicates the allocations for each customer to the respective customers via the network.

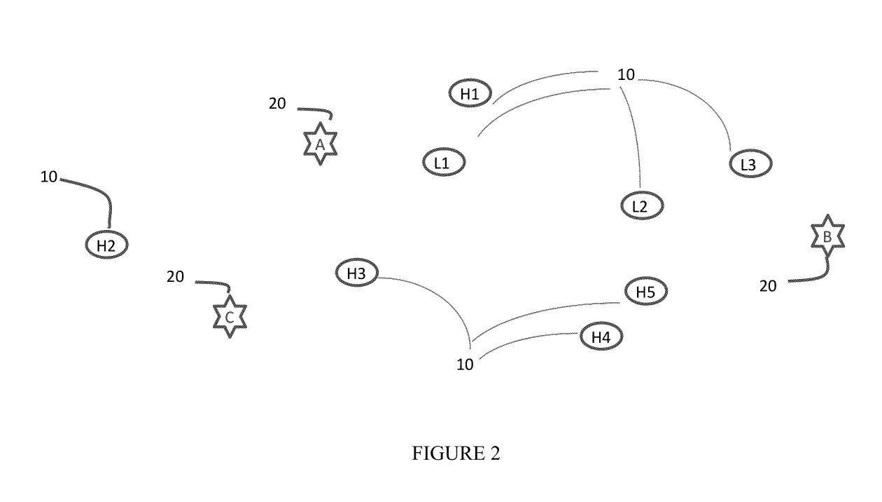

FIG. 2 is a graphical representation of a task allocation problem for a service provider. While the illustrated specific example may be small enough that an optimum solution may be practical, the example is for discussion purposes, and is used to illustrate various aspects and principles that may be applied to task allocation problems that are large enough that an optimum solution is not practical.

The problem presented in FIG. 2 includes multiple appraisers 20 and multiple appraisal tasks 10, which, for example, are to be completed according to a deadline associated with the task allocation process. For example, the appraisal tasks 10 may be due for completion by a “next day” deadline. In some embodiments, tasks may be due for completion by another time period, for example, by a next hour, by a next week, or by a next month. In this FIG. 2 example, each of the appraisal tasks 10 is given an urgency ranking of H (high) or L (low). In addition, each of the appraisal tasks 10 is given a task number for identification. Accordingly, it can be seen that there are five high-urgency tasks labeled H1-H5, and there are also three low-urgency tasks labeled L1-L3. In addition, there are three appraisers 20 labeled A, B, and C. Tasks are to be allocated to each of the appraisers 20 so that the appraisal tasks 10 may be completed the following day.

Each of the appraisers 20 has certain predetermined attributes. For example, each appraiser 20 may be associated with a geographical location, which, for example, may be their home location or their office location. In addition, each of the appraisers 20 may have a schedule, which may include fixed events, such as a meeting from 10 AM to 11 AM, and/or may include sliding events, such as a one hour lunch break anytime between 11 AM and 1 PM, or another event having a duration, and earliest start time, and a latest end time. Additional appraiser attributes may include certifications of certain types of appraisals, or an affinity for certain customers or certain types of customers. For example, each appraiser may be required for or may be precluded from servicing certain customers. In some embodiments, appraiser attributes may include at least one attribute of a set of attributes: appraiser skills, work day start time, and work day end time. The appraisers 20 may have other attributes.

Each of the appraisal tasks 10 has certain predetermined attributes. For example, each task 10 may be associated with a geographical location. In addition, each of the appraisal tasks 10 may have a schedule of availability, such as between 1 PM and 5 PM. Additional task attributes may include a type of appraisal, or that the property includes a pool or other special feature. Task attributes may additionally or alternatively include an affinity indicator or designator for certain appraisers. For example, each task may have a list of one or more required or precluded appraisers. In some embodiments, task attributes additionally or alternatively include a start time, or an end time. The tasks 10 may have other attributes as well.

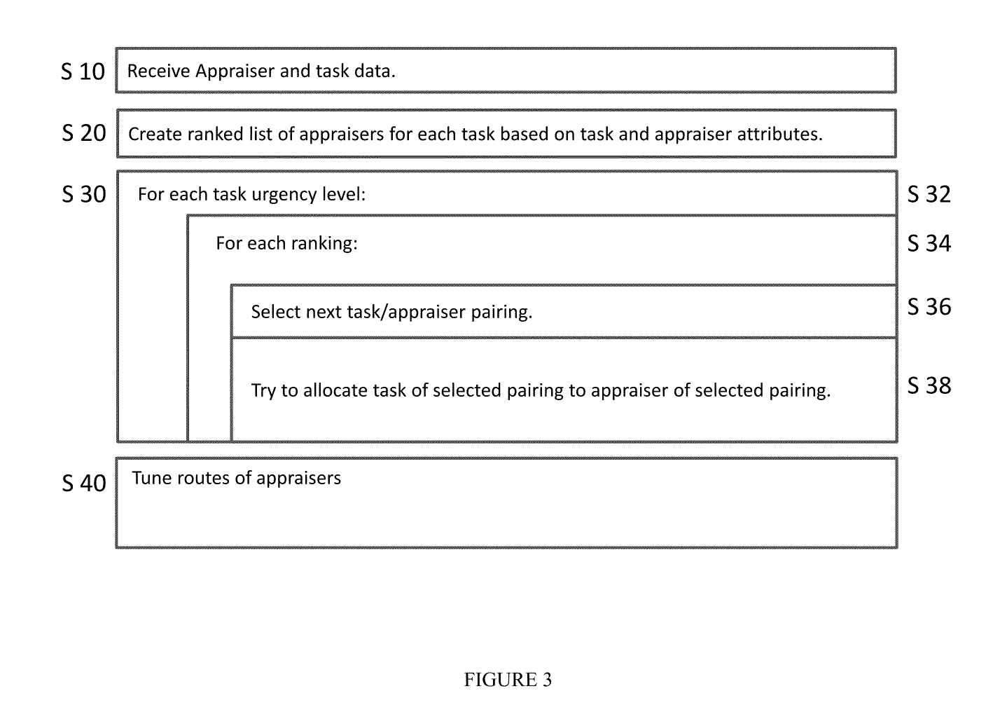

FIG. 3 is a structured flowchart diagram illustrating a method performed by a computer, such as a server, to allocate tasks as described herein.

In the first computer operation, step S 10 of FIG. 3, the computer receives data associated with the tasks and the appraisers. The data includes the geographical locations associated with each of the tasks and with each of the appraisers. The data also includes the appraiser attributes and the task attributes. In some embodiments, the data is tested by the computer to ensure validity and usability of the data before further proceeding.

In step S 20, the computer generates a list of eligible appraisers for each task. For example, each task may have certain requirements as defined by the task attributes. In addition, based on the appraiser attributes, each appraiser has certain predetermined qualifications. For example, the task attributes for one of the tasks may include that the appraisal is for an electric car. Certain appraisers may be certified in appraising such cars. In step S 20, for each task, the computer generates a list of eligible appraisers based on the task attributes and the appraiser attributes. As a result, for the task of the appraisal of the electric car, only appraisers having the appropriate certification are included in the list.

In addition, at step S 20, the computer ranks the eligible appraisers for each of the tasks. The ranks of the eligible appraisers provide a metric for each of the eligible appraisers, whereby the appraisers may be compared when selecting one of the appraisers to which a task is to be assigned. For example, for each particular task, each of the appraisers eligible for the particular task receives a ranking indicating a relative appropriateness or desirability or preference of an assignment of the particular task to each of the eligible appraisers. In some embodiments, the rankings are based on the distance between the geographical location associated with each of the appraisers and the geographical location of each particular task. In such embodiments, rank 1, the top ranking, may be assigned to the appraiser geographically closest to the task. Additionally or alternatively, the rankings may be based on any other appraiser attribute and any other task attribute.

At the conclusion of step S 20, for each of the tasks, the computer has generated a ranked list of eligible appraisers. The rank lists are later used by the computer to allocate tasks among the appraisers, as described below.

In step S 30, the computer allocates tasks to appraisers based in part on the ranked list generated in step S 20. To do this, at step S 32, the computer determines a set of tasks having a next highest urgency level. For example, in step S 32, the computer starts the process using tasks having the highest urgency level, and changes the urgency level towards levels of less urgency as sets of tasks are allocated. For example, the computer may select all of the un-allocated tasks having the highest urgency level for inclusion in the set of tasks. As a result, tasks are allocated in order of urgency, starting with the highest and proceeding to the lowest. For each set of tasks determined in S 32, the computer performs steps S 34, S 36, and S 38, as described further below. Once the computer has performed S 34, S 36, and S 38 for each of the sets of tasks determined in S 32, the computer performs step S 40 described below.

At S 34, the computer determines a next highest ranking. For example, in step S 34, the computer starts the processing using rankings indicating a highest appropriateness of an allocation between a particular task and a particular appraiser, and changes the ranking towards rankings of less appropriateness once task/appraiser pairings of higher appropriateness are considered for task allocation. For example, the computer begins the processing using rank 1. Once the rank 1 task/appraiser pairings are considered for allocation (discussed below), the computer again searches the ranked lists of appraisers for each of the unallocated tasks to determine task/appraiser pairings indicating a next highest appropriateness of allocation.

At the conclusion of step S 34, the computer has compiled a list of task/appraiser pairings to be considered for allocation. In some embodiments, certain task/appraiser pairings may be excluded from the list. For example, if a particular task/appraiser pairing has been previously considered, a repeat consideration of the particular task/appraiser pairing may be precluded. This may be accomplished, for example, by maintaining a list of failed allocations for task/appraiser pairings. As part of step S 34, the computer may reference the list of failed allocations, and exclude any task/appraiser pairings on the list from the list of task/appraiser pairings to be considered for allocation.

At S 36, the computer selects a next pairing for consideration from the list of task/appraiser pairings to be considered for allocation. Any method of selection may be used.

At S 38, the computer determines whether the task of the selected task/appraiser pairing may be allocated to the appraiser of the selected task/appraiser pairing. To do this, the computer may compare the schedule of the appraiser of the selected task/appraiser pairing with the expected task duration as included in the task attributes of the task of the selected task/appraiser pairing, and with expected travel time calculated based on at least one of the location of a next previous task allocated to the appraiser of the selected task/appraiser pairing, the home of the appraiser of the selected task/appraiser pairing, and a current location of the appraiser of the selected task/appraiser pairing. In some embodiments, allocation of the task of the selected task/appraiser pairing may be conditioned on sufficient time for the appraiser of the selected task/appraiser pairing to travel home by a certain time after completing the task of the selected task/appraiser pairing. For example, the computer may compare durations of available time slots in the schedule of the appraiser of the selected task/appraiser pairing with a time calculated for the task of the selected task/appraiser pairing, where the calculated time is based at least in part on travel time and task duration. If the schedule of the appraiser of the selected task/appraiser pairing does not accommodate the task of the selected task/appraiser pairing, the task of the selected task/appraiser pairing is not allocatable to the appraiser of the selected task/appraiser pairing. In response, the computer returns to S 36, where the computer selects a next pairing for consideration from the list of task/appraiser pairings to be considered for allocation.

In some embodiments, the computer determines that the task of the selected task/appraiser pairing may not be allocated to the appraiser of the selected task/appraiser pairing based on other factors, not described herein. If, for any reason, the computer determines that the task of the selected task/appraiser pairing may not be allocated to the appraiser of the selected task/appraiser pairing, the computer may add the selected task/appraiser pairing to the list of failed allocations.

If, however, the schedule of the appraiser of the selected task/appraiser pairing does accommodate the task of the selected task/appraiser pairing, the computer allocates the task of the selected task/appraiser pairing to the appraiser of the selected task/appraiser pairing. The computer then modifies the schedule of the appraiser of the selected task/appraiser pairing to include the newly allocated task. The modification is made according to task attributes of the newly allocated task. After the task is allocated, the computer returns to step S 36 for selection of a next pairing to be considered for allocation.

At the conclusion of step S 30, various tasks have been allocated among the appraisers. However, the scheduled sequence of the tasks allocated to each appraiser has been determined based on the order the tasks were allocated. This schedule sequence might be improved through optimization.

At S 40, the task schedule for each of the appraisers is optimized. Various optimization routines may be used, which will be known to those skilled in the art. In some embodiments, the locations of the tasks for an appraiser are used as a basis for optimizing the route of the appraiser. For example, the task located nearest the home or next previous task of the appraiser may be scheduled as the next task to be completed. In some embodiments, selection of a next task to be completed is based at least in part on a geometric analysis of an appraiser/task representation on a plot or map of the geographic area. For example, for each candidate next task, an angle may be determined, where the determined angle is formed between first and second line segments. The first line segment connects the current task and the next previous task and the second line segment connects the current task and the candidate next task. Candidate next tasks having angles nearest 180° may be preferred in the selection process. In some embodiments, candidate next tasks having angles nearest 0° may be preferred in the selection process. In some embodiments, candidate next tasks having angles nearest another particular angle may be preferred in the selection process.

Once the task schedule for the appraisers has been optimized, the schedule of one or more of the appraisers may have been optimized such that it could accommodate one or more additional tasks. Accordingly, in some embodiments, steps S 10 through S 40 may be repeated one or more times to add additional tasks to the routes and schedules of the appraisers.

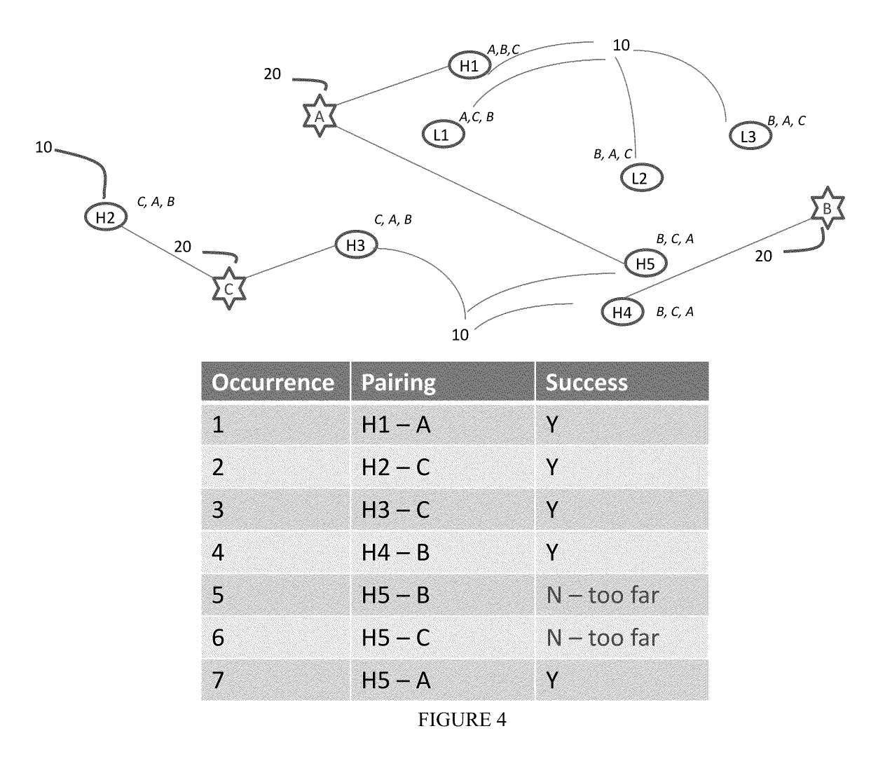

FIG. 4 is a graphical illustration of a task allocation problem for a service provider, and includes a table of steps taken by the computer in performing the method of FIG. 3 to determine a solution. The problem illustrated in FIG. 4 includes appraisers 20 and appraisal tasks 10. Each of the appraisal tasks 10 is given an urgency ranking of H (high) or L (low) and a numerical identifier as in FIG. 2. In addition, each of the tasks 10 includes a list of appraisers 20 in order of ranking.

The table of FIG. 4 illustrates the activity at each occurrence of step S 38 as a computer performs the method represented by the structured flow diagram of FIG. 3. The operations of S 38 are performed iteratively, each occurrence after another. In each occurrence of step S 38, the computer considers whether the task of the task/appraiser pairing selected in step S 36 may be allocated to the appraiser of the task/appraiser pairing selected in step S 36, and allocates the task if appropriate. The computer otherwise considers a next task/appraiser pairing for allocation.

Prior to occurrence 1 of step S 38, the computer selects ranking 1 in step S 34 and selects task/appraiser pairing H1-A in step S 36. In occurrence 1 of S 38, represented by the data in the table for the row marked “Occurrence 1”, the computer determines that task H1 may be allocated to appraiser A based on, for example, task H1 being less than a maximum distance from the home of appraiser A, such that appraiser A has sufficient time to travel to task H1, complete task H1, and have a lunch break during a lunch break window.

The computer then repeats step S 36, selecting the task/appraiser pairing H2-C. In occurrence 2 of S 38, the computer determines that task H2 may be allocated to appraiser C. Likewise, the computer repeats step S 36, selecting task/appraiser pairing H3-C. In occurrence 3 of S 38, the computer determines that task H3 may be allocated to appraiser C.

The computer then repeats step S 36, selecting the task/appraiser pairing H4-B. In occurrence 4 of S 38, the computer determines that the task H4 may be allocated to appraiser B.

The computer then repeats step S 36, selecting task/appraiser pairing H5-B. In occurrence 5 of S 38, the computer determines that the task H5 may not be allocated to appraiser B based on, for example task H5 being greater than a maximum distance from the previous task (H4) of appraiser B.

Because there are no more rank 1 pairings, the computer then repeats step S 34 and selects the next highest ranking, 2, for the unallocated tasks.

The computer then performs step S 36, selecting task/appraiser pairing H5-C. In occurrence 6 of S 38, the computer determines that task H5 may not be allocated to appraiser C based on, for example task H5 being greater than a maximum distance from the house of appraiser C.

The computer then repeats step S 36, selecting task/appraiser pairing H5-A. In occurrence 7 of S 38, the computer determines that task H5 may be allocated to appraiser A.

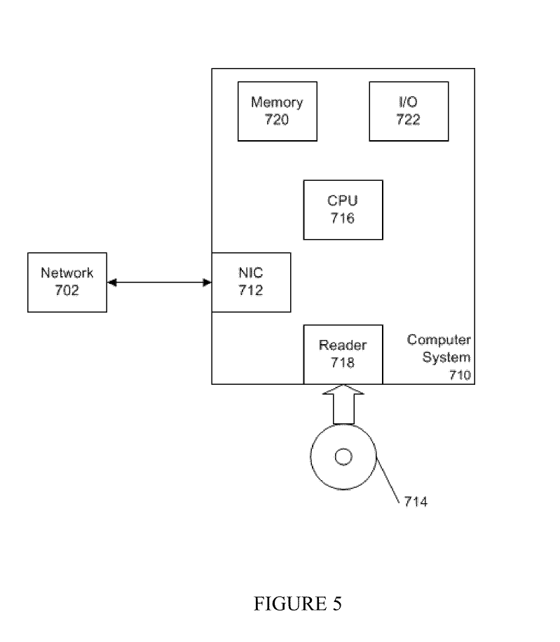

FIG. 5 shows a configuration for a computer system 710 constructed in accordance with the present disclosure for performing the operations described herein. The computer system 710 can comprise a system such as a personal computer or server computer or the like. The computer system 710 may include a network communication interface 712 that permits communications with a network 702. The network interface can comprise a network interface card (NIC). The computer system 710 can execute instructions to provide a computer system which performs various aspects and principles of the methods and features described herein for the computer of FIGS. 1-4.

The computer system 710 includes a central processor unit 716 (CPU) and a program product reader 718 for receiving a program product media and reading program instructions recorded thereon, where the instructions, when executed by the CPU of the computer system cause the computer to perform various aspects and principles of the methods and features described herein. The computer system also includes associated memory 720 and input/output facilities 722, which may include systems such as a display for output and a keyboard and/or mouse for input. The processor 716 of the computer system 710 can receive program instructions into the program memory of the processor. The program instructions can be received directly, such as by flashing EEPROM of the processor, or can be received through the network interface 712, such as by download from a connected device or over a WAN or LAN network communication. If desired, the program instructions can be stored on a computer program product 714 that is read by the computer system 710 so that the program instructions can thereafter be executed. That is, the program product 714 is for use in a system such as the computer system 710, wherein the program product comprises a tangible, non-transitory recordable media containing a program of computer-readable instructions that are executable by the CPU 716 to perform the operations described herein. The program product 714 can comprise, for example, optical program media such as CD or DVD data discs, or flash memory drives, or external memory stores, or floppy magnetic disks, and the like.

The present invention has been described above in terms of presently preferred embodiments so that an understanding of the present invention can be conveyed. There are, however, many configurations for network devices and management systems not specifically described herein but with which the present invention is applicable. The present invention should therefore not be seen as limited to the particular embodiments described herein, but rather, it should be understood that the present invention has wide applicability with respect to network devices and management systems generally. All modifications, variations, or equivalent arrangements and implementations that are within the scope of the attached claims should therefore be considered within the scope of the invention.

What is claimed is:

1. A computer implemented method of allocating a plurality of tasks to a plurality of servicers, the method comprising:
generating a plurality of task/servicer pairings, each pairing identifying one of the tasks and one of the servicers;
generating a rank for each of the generated pairings;
selecting a first pairing from the generated pairings, wherein the first pairing is selected based at least in part on the rank of the first pairing, wherein the first pairing identifies a first task and a first servicer;
determining whether the first task is allocatable to the first servicer;
allocating the selected first task to the selected first servicer in response to the selected first task being allocatable to the selected first servicer; and
in response to the selected first task not being allocatable to the selected first servicer, selecting a second pairing from the pairings.

2. The method of claim 1, wherein generating the pairings comprises determining which servicers are eligible for allocation of each of the tasks, and generating pairings which each include one of the tasks and one of the servicers eligible for the one task.

3. The method of claim 2, wherein determining which services are eligible comprises performing an analysis of task attributes and servicer attributes.

4. The method of claim 1, wherein the rank of each particular pairing indicates a desirability of an allocation of the task of the particular pairing to the servicer of the particular pairing relative to an allocation of the task of the particular pairing to one or more other servicers.

5. The method of claim 4, wherein the rank of each particular pairing indicates a relative proximity of a geographical location associated with the servicer of each pairing and a geographical location associated with the task of each pairing.

6. The method of claim 4, further comprising selecting a group of pairings having the same rank, wherein the first pairing is selected from the group of pairings.

7. The method of claim 1, wherein determining whether the first task is allocatable to the first servicer comprises determining whether the schedule of the first servicer accommodates the first task.

8. The method of claim 7, wherein determining whether the schedule of the first servicer accommodates the first task comprises comparing durations of available time slots in the schedule of the first servicer with a time calculated for the first task wherein the calculated time is based at least in part on travel time and task duration.

9. A computer system, comprising:
a processor; and
a memory, comprising instructions, which when executed by the process cause the computer system to perform a method of allocating a plurality of tasks to a plurality of servicers, the method comprising:
generating a plurality of task/servicer pairings, each pairing identifying one of the tasks and one of the servicers;
generating a rank for each of the generated pairings;
selecting a first pairing from the generated pairings, wherein the first pairing is selected based at least in part on the rank of the first pairing, wherein the first pairing identifies a first task and a first servicer;
determining whether the first task is allocatable to the first servicer;
allocating the selected first task to the selected first servicer in response to the selected first task being allocatable to the selected first servicer; and
in response to the selected first task not being allocatable to the selected first servicer, selecting a second pairing from the pairings.

10. The system of claim 9, wherein generating the pairings comprises determining which servicers are eligible for allocation of each of the tasks, and generating pairings which each include one of the tasks and one of the servicers eligible for the one task.

11. The system of claim 10, wherein determining which services are eligible comprises performing an analysis of task attributes and servicer attributes.

12. The system of claim 9, wherein the rank of each particular pairing indicates a desirability of an allocation of the task of the particular pairing to the servicer of the particular pairing relative to an allocation of the task of the particular pairing to one or more other servicers.

13. The system of claim 12, wherein the rank of each particular pairing indicates a relative proximity of a geographical location associated with the servicer of each pairing and a geographical location associated with the task of each pairing.

14. The system of claim 12, wherein the method further comprises selecting a group of pairings having the same rank, wherein the first pairing is selected from the group of pairings.

15. The system of claim 9, wherein determining whether the first task is allocatable to the first servicer comprises determining whether the schedule of the first servicer accommodates the first task.

16. The system of claim 15, wherein determining whether the schedule of the first servicer accommodates the first task comprises comparing durations of available time slots in the schedule of the first servicer with a time calculated for the first task wherein the calculated time is based at least in part on travel time and task duration.

17. A computer readable medium comprising non-transient instructions, which, when executed by a computer, cause the computer to perform a method of allocating a plurality of tasks to a plurality of servicers, the method comprising:
generating a plurality of task/servicer pairings, each pairing identifying one of the tasks and one of the servicers;
generating a rank for each of the generated pairings;
selecting a first pairing from the generated pairings, wherein the first pairing is selected based at least in part on the rank of the first pairing, wherein the first pairing identifies a first task and a first servicer;
determining whether the first task is allocatable to the first servicer;
allocating the selected first task to the selected first servicer in response to the selected first task being allocatable to the selected first servicer; and
in response to the selected first task not being allocatable to the selected first servicer, selecting a second pairing from the pairings.

18. The computer readable medium of claim 17, wherein generating the pairings comprises determining which servicers are eligible for allocation of each of the tasks, and generating pairings which each include one of the tasks and one of the servicers eligible for the one task.

19. The computer readable medium of claim 18, wherein determining which services are eligible comprises performing an analysis of task attributes and servicer attributes.

20. The computer readable medium of claim 17, wherein the rank of each particular pairing indicates a desirability of an allocation of the task of the particular pairing to the servicer of the particular pairing relative to an allocation of the task of the particular pairing to one or more other servicers.

21. The computer readable medium of claim 20, wherein the rank of each particular pairing indicates a relative proximity of a geographical location associated with the servicer of each pairing and a geographical location associated with the task of each pairing.

22. The computer readable medium of claim 20, wherein the method further comprises selecting a group of pairings having the same rank, wherein the first pairing is selected from the group of pairings.

23. The computer readable medium of claim 17, wherein determining whether the first task is allocatable to the first servicer comprises determining whether the schedule of the first servicer accommodates the first task.

24. The computer readable medium of claim 23, wherein determining whether the schedule of the first servicer accommodates the first task comprises comparing durations of available time slots in the schedule of the first servicer with a time calculated for the first task wherein the calculated time is based at least in part on travel time and task duration.
